(19) United States
(12) Patent Application Publication
(10) Pub. No.: US 2009/0016302 A1
(43) Pub. Date: Jan. 15, 2009

(54) OPTIMIZED MOBILITY MANAGEMENT PROCEDURES USING PRE-REGISTRATION TUNNELING PROCEDURES

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/169,775

(22) Filed: Jul. 9, 2008

Related U.S. Application Data
(60) Provisional application No. 60/948,556, filed on Jul. 9, 2007.
(60) Provisional application No. 60/949,086, filed on Jul. 11, 2007.

(51) Int. Cl. H04Q 7/20

(52) U.S. Cl. 370/331

(57) ABSTRACT

A method and apparatus for optimizing mobility management procedures comprises establishing a tunnel between a wireless transmit/receive unit (WTRU) and a target system core network (CN). The WTRU is handed over from a source system CN system to the target system CN.

### CROSS REFERENCE TO RELATED APPLICATIONS

This application claims the benefit of U.S. provisional application No. 60/948,556, filed Jul. 9, 2007 and U.S. provisional application No. 60/949,086, filed Jul. 11, 2007, which are incorporated by reference as if fully set forth.

### FIELD OF INVENTION

The present invention is related to wireless communication systems.

### BACKGROUND

A dual-mode or multi-mode wireless transmit/receive unit has dual or multiple radio transceivers, each designed to communicate on a particular radio access technology (RAT), such as 3^{rd} Generation Partnership Project (3GPP) and non-3GPP systems. The handover process between 3GPP and non-3GPP systems may be slow due to the nature of the system configurations and operations. One problem occurs when a WTRU moves from one system to another as the WTRU is required to register and authenticate in the other system. A similar problem exists for session initiation protocol (SIP)-based Session Continuity processes between 3GPP and non-3GPP systems. When moving from one system to the other, the WTRU is required to register and authenticate in the other system before registering with internet protocol (IP) multimedia subsystem (IMS).

Another problem may occur due to the 3GPP prohibition against simultaneous radio transceiver operation. A single WTRU cannot have a 3GPP radio transceiver and a non-3GPP radio transceiver active at the same time. In such cases, dual-mode or multi-mode radio transceivers need sophisticated control of the radio switching.

It would therefore be beneficial to provide an improved method and apparatus for handover.

### SUMMARY

A method and apparatus are disclosed to optimize mobility management procedures using pre-registration tunneling. The method and apparatus comprise establishing a tunnel between a wireless transmit/receive unit (WTRU) and a target system core network (CN). The WTRU is handed over from a source system CN system to the target system CN.

### BRIEF DESCRIPTION OF THE DRAWINGS

A more detailed understanding may be had from the following description, given by way of example in conjunction with the accompanying drawings wherein:

FIG. 1 is a block diagram of dual stack operation in a multi-mode WTRU in accordance with one embodiment of the present invention;

FIG. 2 is a block diagram of dual stack operation in a multi-mode WTRU for SIP based continuity in 3GPP to non-3GPP handover in accordance with the present invention;

FIG. 3 is a block diagram of dual stack operation in a multi-mode WTRU for SIP based continuity in non-3GPP to 3GPP handover in accordance with the present invention;

FIGS. 4A and 4B are a signal diagram of pre-registration and preauthentication for 3GPP to non-3GPP handover in accordance with the disclosed method;

FIGS. 5A and 5B are a signal diagram of pre-registration and preauthentication for 3GPP to non-3GPP handover in accordance with the disclosed method;

FIGS. 6A, 6B and 6C are a signal diagram of pre-registration for 3GPP to non-3GPP handover in accordance with the present invention; and

FIGS. 7A, 7B and 7C are a signal diagram of pre-registration for a non-3GPP to 3GPP handover in accordance with the present invention.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

By way of reference, as a WTRU moves from a system A to a system B, system A is defined as the source system and system B is defined as the target system. In accordance with a disclosed method, to speed access procedures to a target system, pre-registration and pre-authentication procedures are performed by higher layers in a WTRU via the source system. This may include IP configuration and SIP registration procedures. In accordance with the disclosed method, the source system identifies the target system, establishes a tunnel between the terminal and the core network (e.g., Autonomous Registration (AR) or Access, Authentication and Accounting (AAA)) of the target system (3GPP2, WiMAX or WiFi, for example), and instructs the WTRU to start access procedures for the target system, such as attach, IP configuration or SIP registration. Upon successful completion of the access procedure and the SIP registration, the source system then instructs the WTRU to switch, or handover, to the target system and turn off the radio connected to the source system.

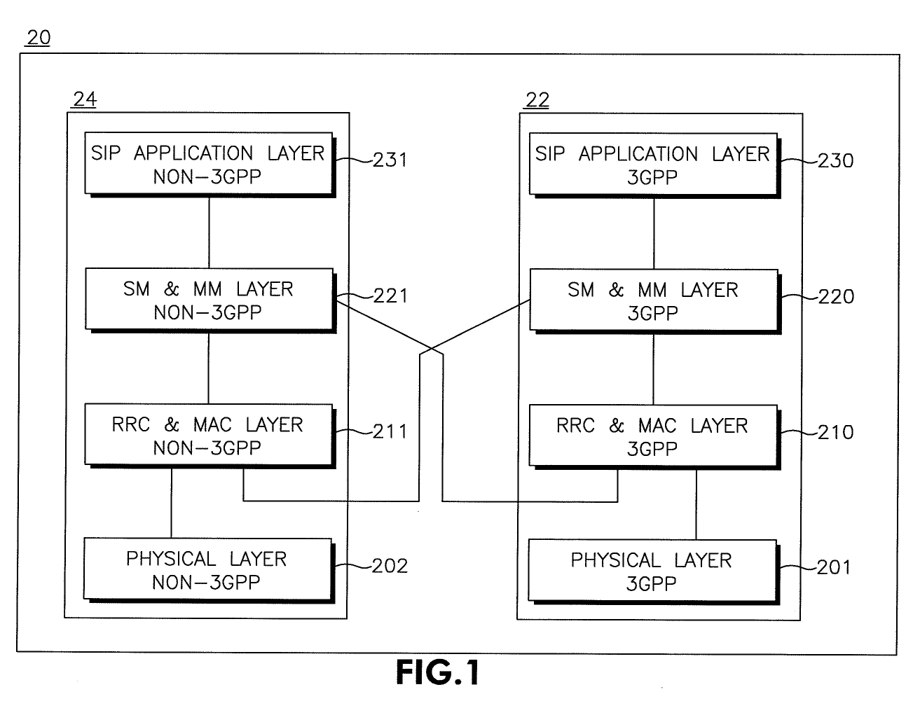

FIG. 1 is a block diagram of a dual stack operation in a multi-mode WTRU 20. As shown in FIG. 1, WTRU 20 comprises a first transceiver 22 and a second transceiver 24. The first and second transceivers 22 and 24, respectively, communicate within a certain network type. A network type may be one of any 3GPP or non-3GPP networks. For purposes of this disclosure, first transceiver 22 is a 3GPP transceiver and second transceiver 24 is a non-3GPP transceiver.

3GPP transceiver 22 and non-3GPP transceiver 24 each include a plurality of layers for processing received and transmitted wireless communications. 3GPP transceiver 22 comprises a physical layer 201 (Layer 1) coupled to a 3GPP radio resource control (RRC) and medium access control (MAC) layer 210 (Layer 2). RRC Layer 210, is coupled to Physical Layer 201, a 3GPP mobility management (MM) and session management (SM) layer 220 (Layer 3) and a non-3GPP SM and MM layer 221, to be disclosed hereinafter. 3GPP MM Layer 220 is coupled to RRC Layer 210 and an application layer (e.g., a session initiation protocol (SIP)) 230 (Layer 4), and a non-3GPP RRC and MAC layer 211, to be disclosed hereinafter. 3GPP Application Layer 230 is coupled to MM Layer 220.

Non-3GPP transceiver 24, similar to 3GPP transceiver 22, comprises a non-3GPP physical layer 201 coupled to a non-3GPP RRC 211. RRC Layer 211 is coupled to Physical Layer 202 and non-3GPP MM layer 221 and 3GPP MM layer 220. Non-3GPP MM layer 221 is coupled to non-RRC Layer 211 and non-3GPP application layer 231 and 3GPP RRC Layer 210. Non-3GPP Application 231 is coupled to MM Layer 221.

In order to accommodate communications by WTRU 20 in 3GPP and non-3GPP systems, in accordance with this disclosed method, 3GPP RRC Layer 210 is in direct communication with non-3GPP MM Layer 221. Likewise, non-3GPP RRC Layer 211 is in direct communication with 3GPP MM Layer 220.

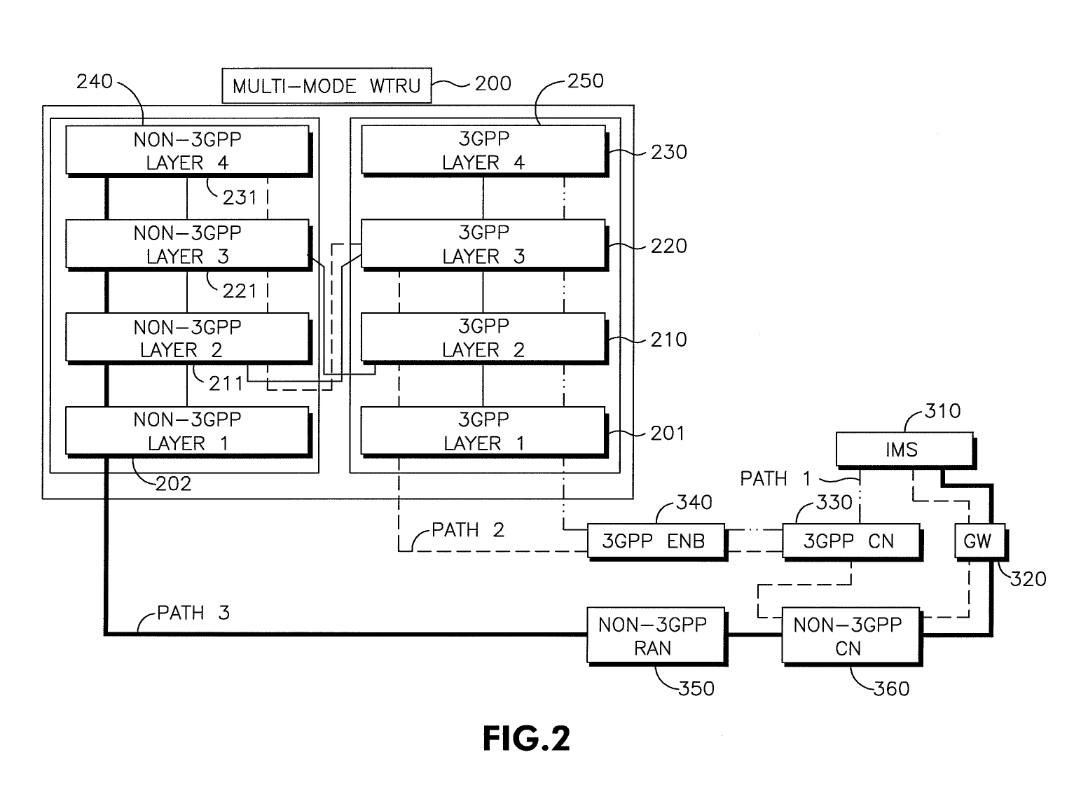

FIG. 2 shows a block diagram of dual stack operation in a multi-mode WTRU 200 for pre-registration, IP configuration and SIP based continuity in 3GPP to non-3GPP handover. Initially, a multi-mode WTRU 200 is communicating on a 3GPP network, through the internal 3GPP layers 201, 210, 220 and 230 in WTRU 200 to a 3GPP e-node B (eNB) 340, then to a 3GPP core network (CN) 330 and to the IP multimedia subsystem (IMS) 310 (Path 1).

During a handover from the 3GPP network to a non-3GPP network, non-3GPP radio transceiver 24 communicates with IMS 310 through 3GPP radio transceiver 250, in accordance with the disclosed method. As such, a communication is sent from non-3GPP Layer 4 231 to Layer 3 221 to non-3GPP Layer 2 211. Non-3GPP Layer 2 211 then forwards the communication to 3GPP Layer 3 220. Layer 3GPP 220 forwards the communication through the 3GPP Layer 2 210 and Layer 1 201 layers, then to 3GPP eNB 340 and 3GPP CN 330. 3GPP CN 330 then communicates directly with non-3GPP CN 360 that communicates with IMS 210 through a gateway 320 (Path 2). Once handover is complete, WTRU 200 communicates with IMS 310 through non-3GPP radio transceiver 240, a non-3GPP radio access network (RAN) 350, non-3GPP CN 360 and gateway 320 (Path 3).

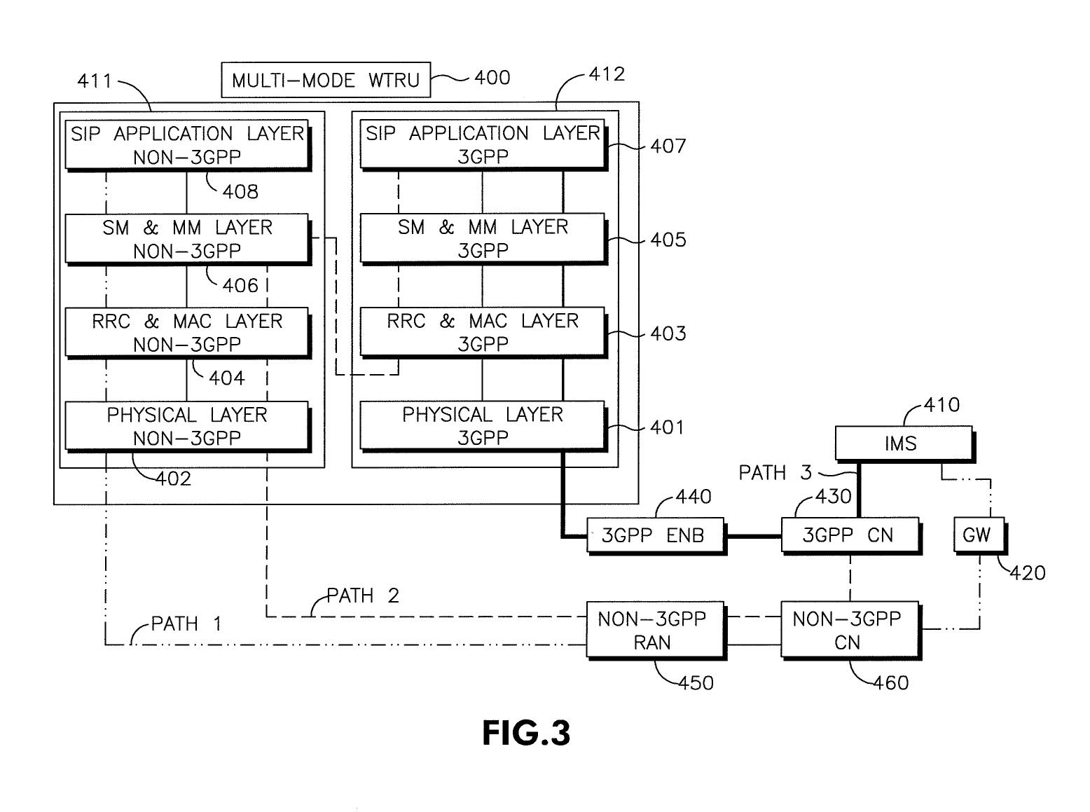

FIG. 3 shows a block diagram of dual stack operation in a multi-mode WTRU for pre-registration, IP configuration and SIP based continuity in non-3GPP to 3GPP handover. Initially, a multi-mode WTRU 400 is communicating on a non-3GPP network through a non-3GPP radio transceiver 411, including internal non-3GPP layers 408, 406, 404 and 402 in WTRU 400, to non-3GPP RAN 450, to non-3GPP CN 460 then to IMS 410 through a gateway 420 (Path 1). During a handover from the non-3GPP network to a 3GPP network, 3GPP radio transceiver 412 communicates with IMS 410 initially through non-3GPP radio transceiver 411. A communication from 3GPP radio transceiver 412 is sent from 3GPP Layers 4 or to 3GPP Layer 3 405 to 3GPP Layer 2 403. Layer 3 403 forwards the communication to non-3GPP Layer 3 406, which then forwards the communication to non-3GPP Layer 3 406, which then forwards the communication to non-3GPP RAN 450 through non-3GPP Layer 2 404 and Layer 1 402. Non-3GPP RAN 450 forwards the communication to non-3GPP CN 430 then forwards the communication to IMS 410 (Path 2). Once handover is complete, WTRU 400 communicates with the IMS through the 3GPP radio transceiver 412 including 3GPP Layer 4 405, 406, 403 and 401, 3GPP eNB 440 and 3GPP CN 430 (Path 3).

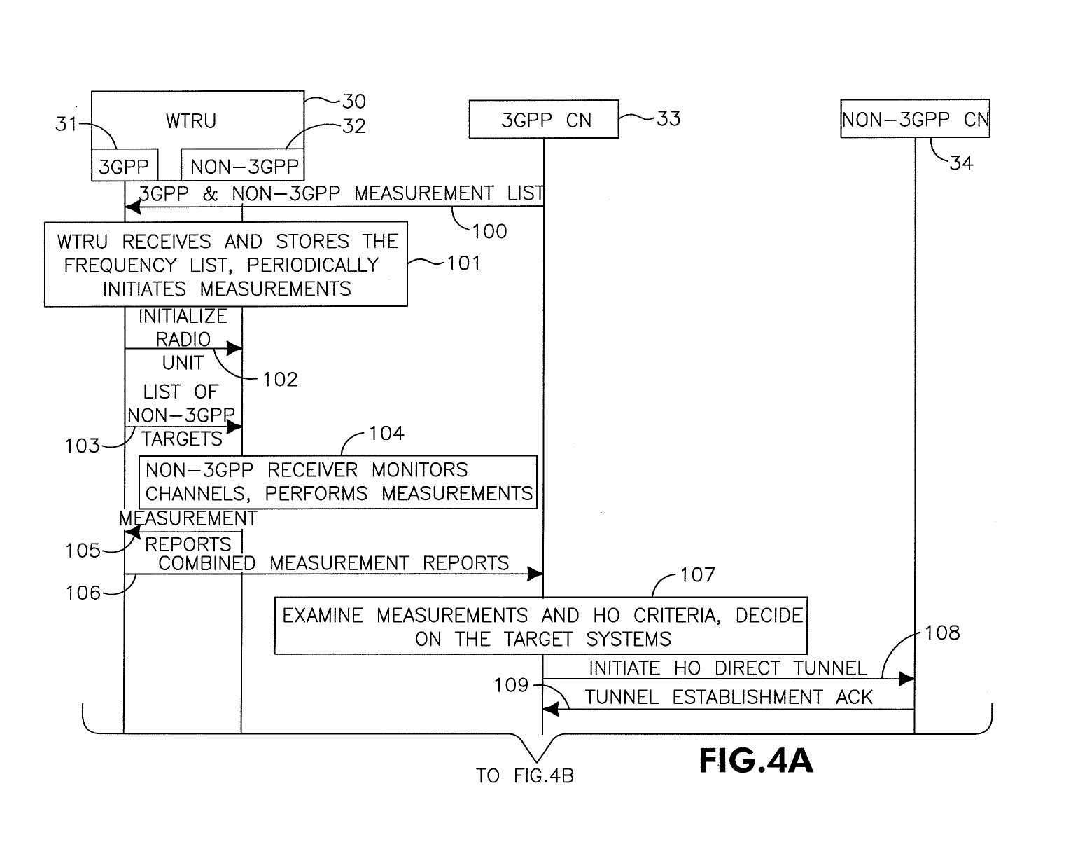

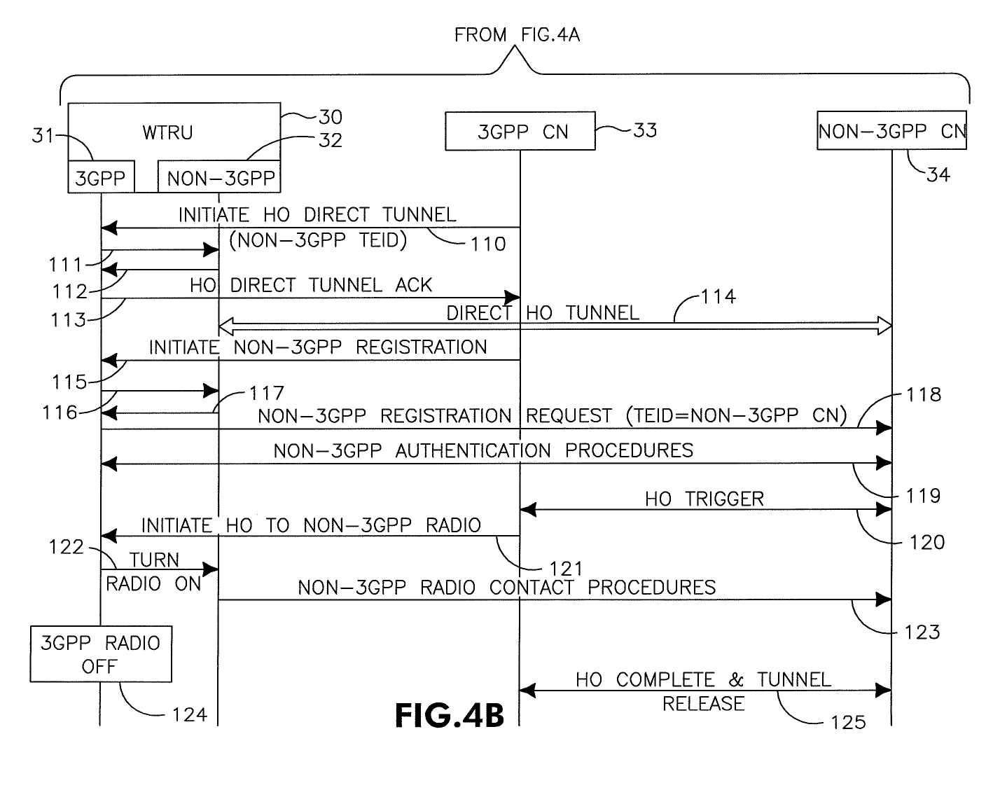

FIG. 4A and 4B are a signal diagram for pre-registration procedure for a handover of a WTRU 30 from a 3GPP handover source 33 to a non-3GPP handover target 34. A WTRU 30 includes a 3GPP radio transceiver 31 and a non-3GPP radio transceiver 32 for communication with a 3GPP core network (CN) 33 and a non-3GPP CN 34. For simplicity, a dual mode WTRU 30 is shown, however the signaling described herein is valid for a multi-mode WTRU having multiple 3GPP and non-3GPP radio transceivers. While shown as direct signals from WTRU 30 and CNs 33, 34, the signals may be relayed by a NodeB or a base station radio transceiver (not shown).

Pre-registration begins with 3GPP transceiver 31 receiving a 3GPP and non-3GPP measurement list 100 from 3GPP CN 33. The measurement list (100) identifies the channel frequencies of candidate handover targets. WTRU 30 stores the list in an internal memory, and for periodically initiating channel measurements (101). 3GPP transceiver 31 sends an initialization signal (102) to non-3GPP transceiver 33, along with a list of candidate non-3GPP handover targets (103). Non-3GPP transceiver 32 is activated for a period in order to perform measurement procedures, in which it monitors channels and performs measurements (104). Non-3GPP transceiver 32 sends measurement reports (105) of the monitored channels to 3GPP transceiver 31. When measurement procedures by non-3GPP transceiver 32 are completed, it may be deactivated.

3GPP transceiver 31 combines the measurements it made with those made by non-3GPP transceiver 32, formulates combined measurement reports, and transmits the combined measurement reports (106) to the 3GPP CN 33. 3GPP CN 33 examines the combined measurement reports and selects a handover target system (107) for WTRU 30. 3GPP CN 33 then sends a signal to target non-3GPP CN 34 to initiate a handover direct tunnel (108), and target non-3GPP CN 34 responds with a tunnel establishment acknowledgment signal (109). 3GPP CN 33 sends a signal to 3GPP transceiver 31 to initiate a handover direct tunnel (110). This signal (110) may include a non-3GPP tunnel endpoint identification (TEID). 3GPP transceiver 31 sends the target ID (111) to non-3GPP transceiver 32. Non-3GPP transceiver 32 sends its handover direct tunnel acknowledgment (ACK) 112 to 3GPP transceiver 31, which is then forwarded to 3GPP CN 33 as signal 113. The direct handover tunnel 114 is established between non-3GPP target CN 34 and non-3GPP transceiver 32. Source 3GPP CN 33 sends a signal to initiate a non-3GPP registration (115) to 3GPP transceiver 31 which is then forwarded as signal (116) to non-3GPP transceiver 32. The upper layers of non-3GPP transceiver 32 perform pre-registration pre-authentication procedures, and send a non-3GPP registration request (117), (118) via 3GPP transceiver 31 to non-3GPP target CN 34.

3GPP radio transceiver 32 and non-3GPP target CN 34 then conduct authentication procedures (119). Handover triggers (120) are communicated directly between 3GPP CN 33 and non-3GPP CN 34 and the 3GPP CN 33 initiates handover with a signal (121) to 3GPP transceiver 31. 3GPP transceiver 31 instructs non-3GPP radio transceiver 32 to turn ON as signal (122). With non-3GPP radio transceiver 32 turned ON, it makes initial contact with non-3GPP CN 34 and commences radio contact procedures (123). 3GPP radio transceiver 31 is turned OFF (124) and 3GPP CN 33 and non-3GPP CN 34 exchange handover complete and tunnel release signals (125).

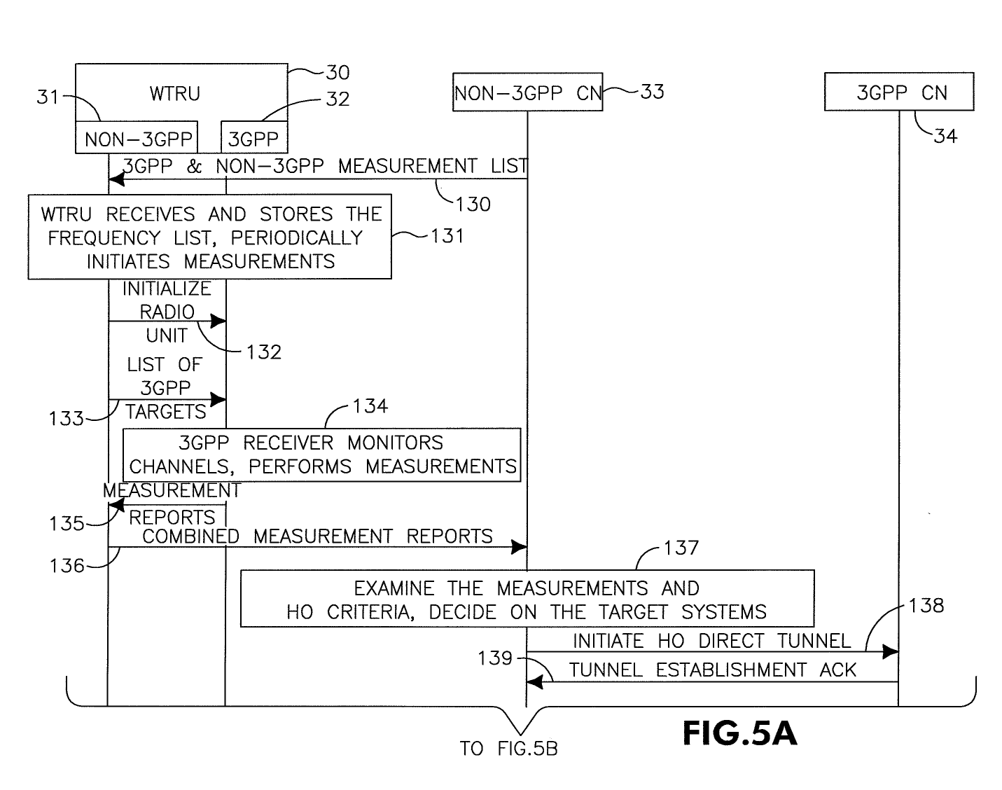

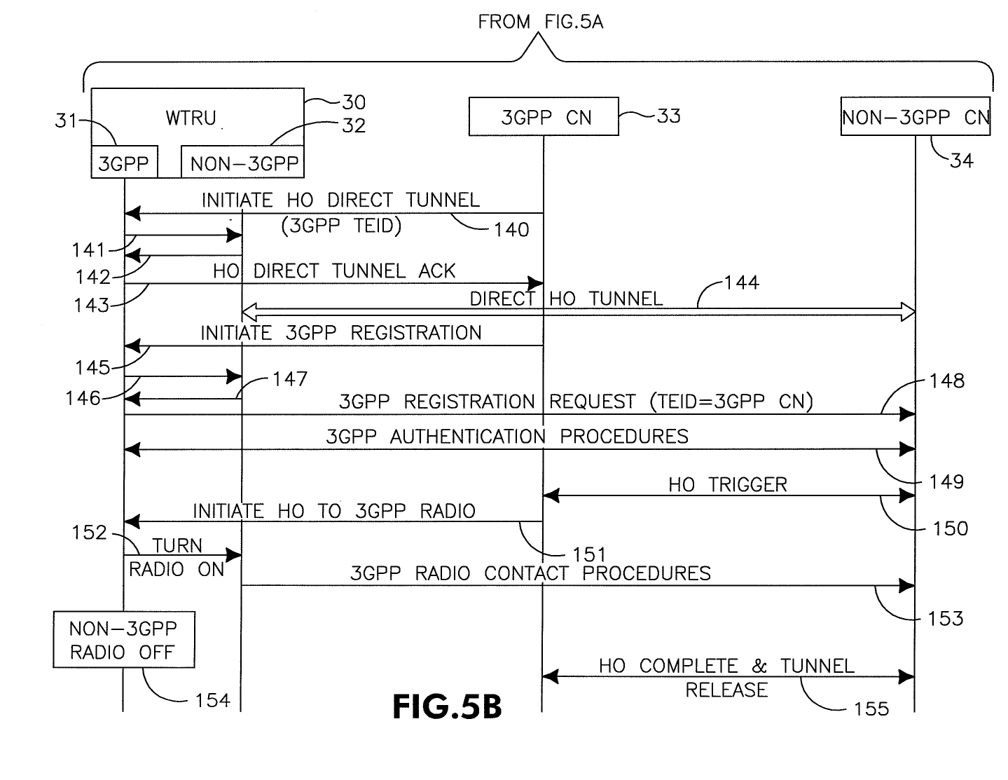

FIG. 5A and 5B are a signal diagram for pre-registration procedure for a handover of a WTRU 30 from a non-3GPP source 33 to a 3GPP 34. WTRU 30 includes a non-3GPP transceiver 31 and a 3GPP radio transceiver 32 for communication with non-3GPP CN 33 and 3GPP CN 34.

Pre-registration begins with non-3GPP transceiver 31 receiving a 3GPP and non-3GPP measurement list (130) from non-3GPP CN 33. Measurement list (130) identifies the channel frequencies of candidate handover targets. WTRU 30 stores the list in an internal memory, and for periodically initiating channel measurements (131). Non-3GPP transceiver 31 sends an initialization signal (132) to 3GPP transceiver 32, along with a list of candidate 3GPP handover targets (133). 3GPP transceiver 32 is activated and monitors channels and performs measurements (134).

3GPP transceiver 32 sends measurement reports (135) of the monitored channels to non-3GPP transceiver 31. Non-3GPP transceiver 31 combines the measurements it made with those made by 3GPP transceiver 32, formulates combined measurement reports, and transmits the combined measurement reports (136) to non-3GPP CN 33. Non-3GPP CN 33 examines the combined measurement reports and selects a handover target system (137) for WTRU 30. Non-3GPP CN 33 sends a signal 34 to target 3GPP CN 34 to initiate a handover direct tunnel (138), and target 3GPP CN 34 responds with a tunnel establishment acknowledgment signal (139). 3GPP non-CN 33 sends a signal to non-3GPP transceiver 31 to initiate a handover direct tunnel (140). Signal 140 may include a 3GPP tunnel endpoint identification (TEID). Non-3GPP transceiver 31 sends the target ID (141) to the 3GPP transceiver 32. 3GPP transceiver 32 sends its handover direct tunnel acknowledgment (ACK) (142) to non-3GPP transceiver 31, which is then forwarded to non-3GPP CN 33 as signal (143). The direct handover tunnel (144) is established between 3GPP target CN 34 and 3GPP transceiver 32. Source non-3GPP CN 33 sends a signal to initiate a 3GPP registration (145) to non-3GPP transceiver 31, which is then forwarded as signal (146) to 3GPP transceiver 32. A 3GPP registration request (147, 148) is sent from 3GPP transceiver 32 via non-3GPP transceiver 31 to 3GPP target CN 34.

Non-3GPP radio transceiver 31 and 3GPP target CN 34 then conduct authentication procedures (149). Handover triggers (150) are communicated directly between non-3GPP CN 33 and 3GPP CN 34, and non-3GPP CN 33 initiates handover with a signal (151) to non-3GPP transceiver 31. Non-3GPP transceiver 31 instructs non-3GPP radio transceiver 32 to turn ON with signal (152). With 3GPP radio transceiver 32 turned ON, it makes initial contact with the 3GPP CN 34 and commences radio contact procedures (153). Non-3GPP radio transceiver 31 is turned OFF (154) and non-3GPP CN 33 and 3GPP CN 34 exchange handover complete and tunnel release signals (158).

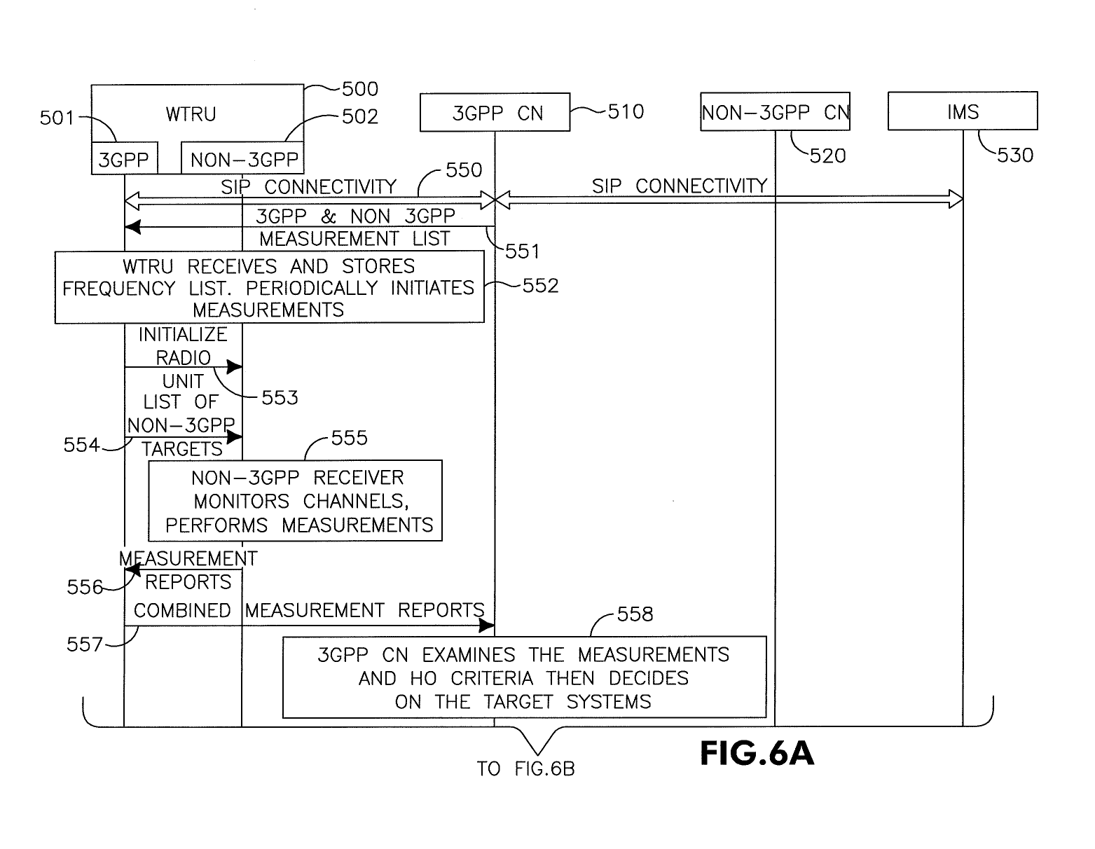

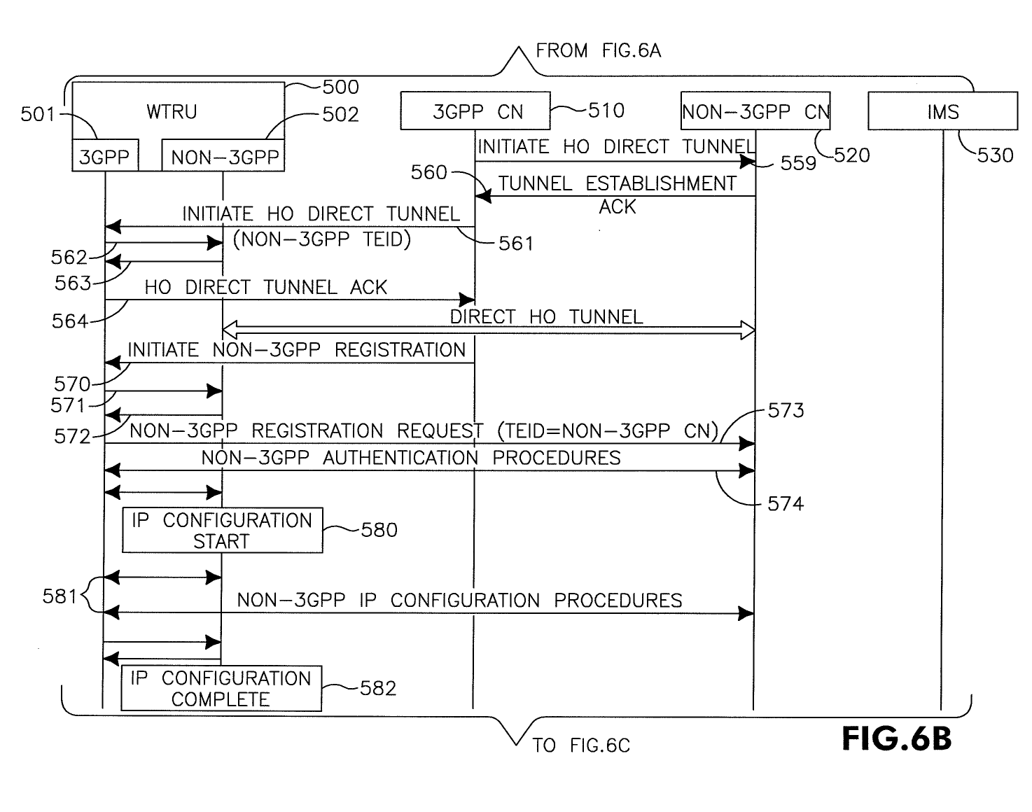

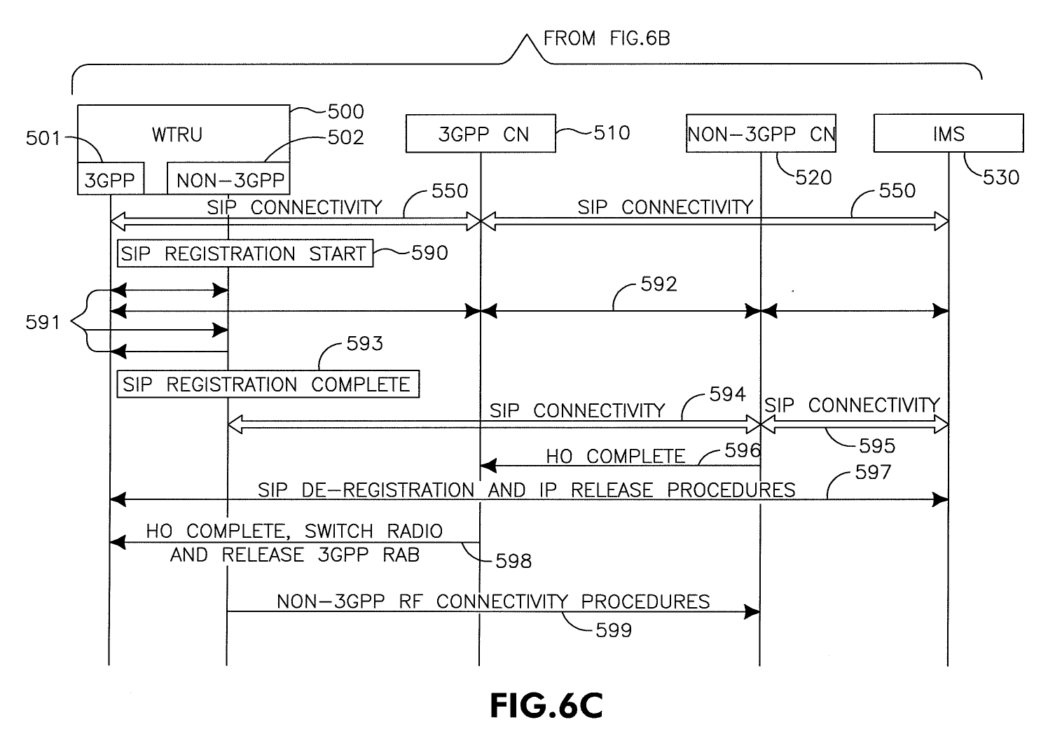

FIGS. 6A, 6B and 6C are a signal diagram for 3GPP to non-3GPP pre-registration. A WTRU 500 includes a 3GPP radio transceiver 501 and a non-3GPP radio transceiver 502. There is a SIP connection (550) between 3GPP radio transceiver 501 in WTRU 500 and a 3GPP CN 510, and from 3GPP CN 510 to an IMS 530. The 3GPP CN 510 transmits a 3GPP and non-3GPP measurement list (551) to WTRU 500. WTRU 500 receives the frequency list and stores the list in internal memory (552). WTRU 500 may then periodically initiate channel measurements.

3GPP radio transceiver 501 in WTRU 500 may then initialize non-3GPP radio transceiver 502 (553) and send non-3GPP radio transceiver 502 a list of non-3GPP targets (554). In turn, non-3GPP radio transceiver 502 may monitor channels and perform measurements (555). The measurement reports can then be sent to 3GPP radio transceiver 501 (556), which then transmit all measurement reports to 3GPP CN 510 (557).

3GPP CN 510 examines the measurement report and handover criteria (558) which may be used to decide on the target system. Once 3GPP CN 510 has decided on the target system, a handover direct tunnel to the targeted non-3GPP CN 520 is initiated (559).

After receiving a tunnel establishment acknowledge message (560) from non-3GPP network 520, 3GPP CN 510 then initiates a direct handover tunnel (561) with non-3GPP radio transceiver 502 in WTRU 500 through 3GPP radio transceiver 501 (562). The handover tunnel preferably is acknowledged by non-3GPP radio transceiver 502 (563) to 3GPP CN 501 (564) and the handover tunnel established.

Once the tunnel is established, 3GPP CN 510 initiates non-3GPP registration. Non-3GPP radio transceiver 502 sends a registration request (572) to non-3GPP CN 520 through 3GPP radio transceiver 501 (573). In the request (573), the tunnel endpoint identifier (TEID) is related to non-3GPP CN 520. 3GPP radio transceiver 501, along with non-3GPP CN 520, then conducts authentication procedures (574, 575).

Preferably, the IP configuration procedures (580) between WTRU 500 and non-3GPP CN 520 are now started (581). Once the IP configuration is complete (582), SIP registration is started (590, 591). Once SIP registration is complete (593), there may be SIP connectivity directly between the 3GPP and non-3GPP CNs (592). 3GPP CN 510 may then instruct WTRU 500 (591) to handover to non-3GPP CN 520. The non-3GPP radio transceiver 502 in WTRU 500 is turned on and contacts non-3GPP CN 520 (594) 3GPP radio transceiver 501 is turned off, and handover is completed (596) and the tunnel released (598).

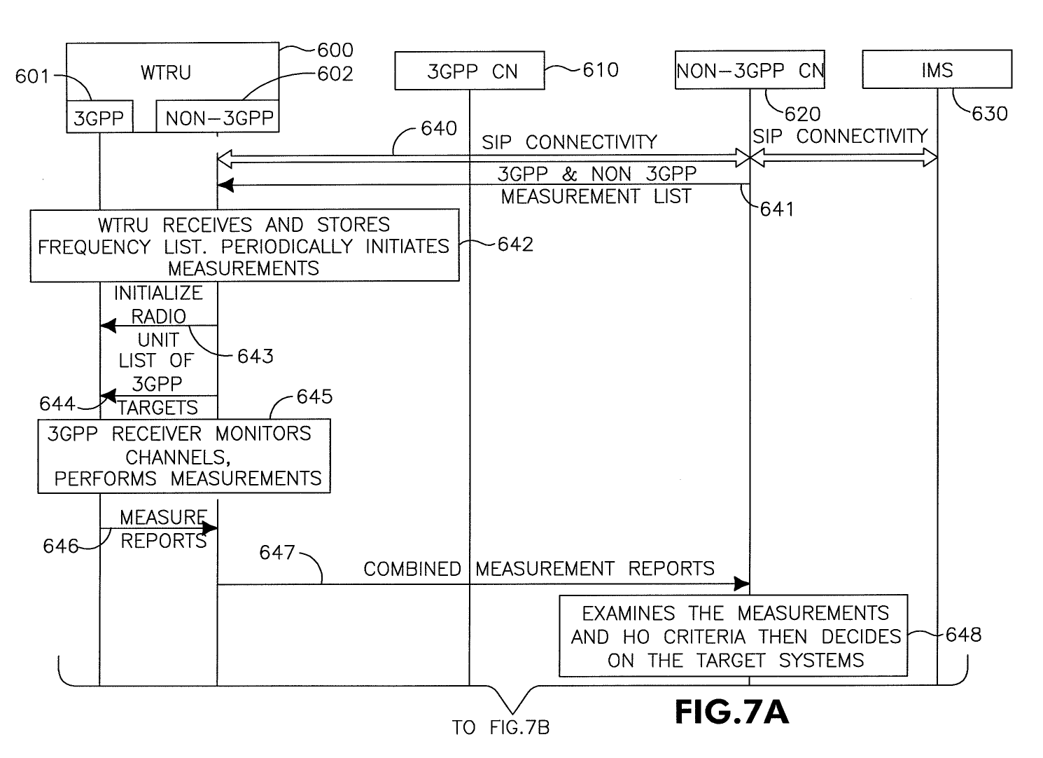

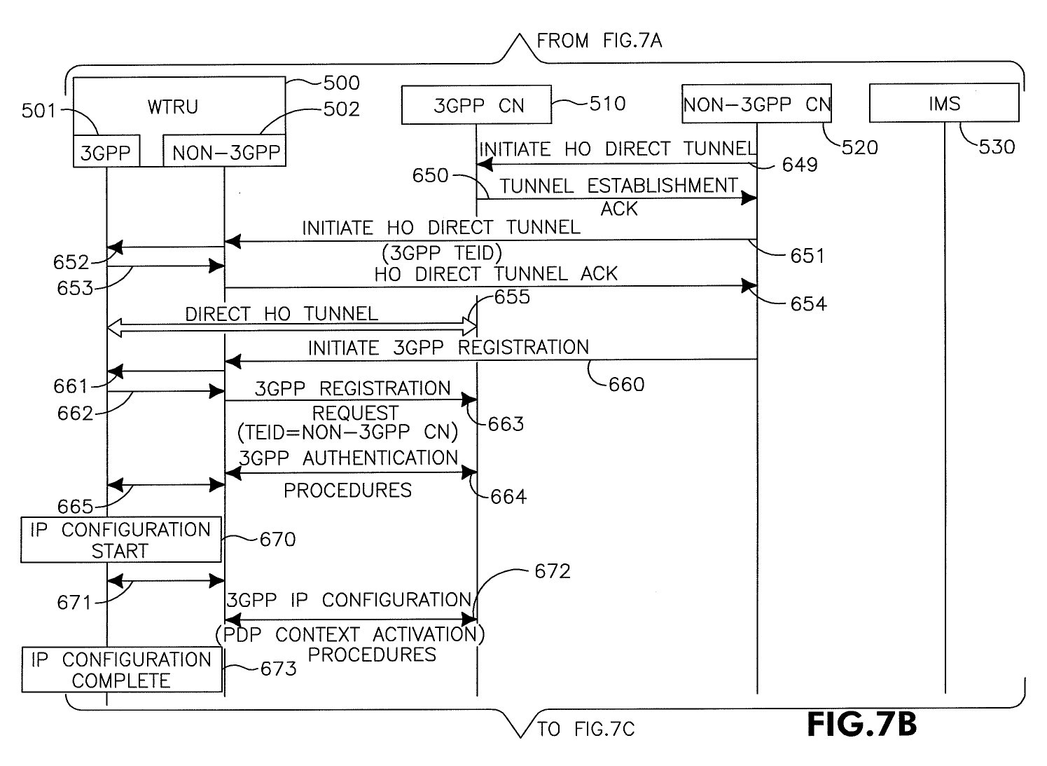

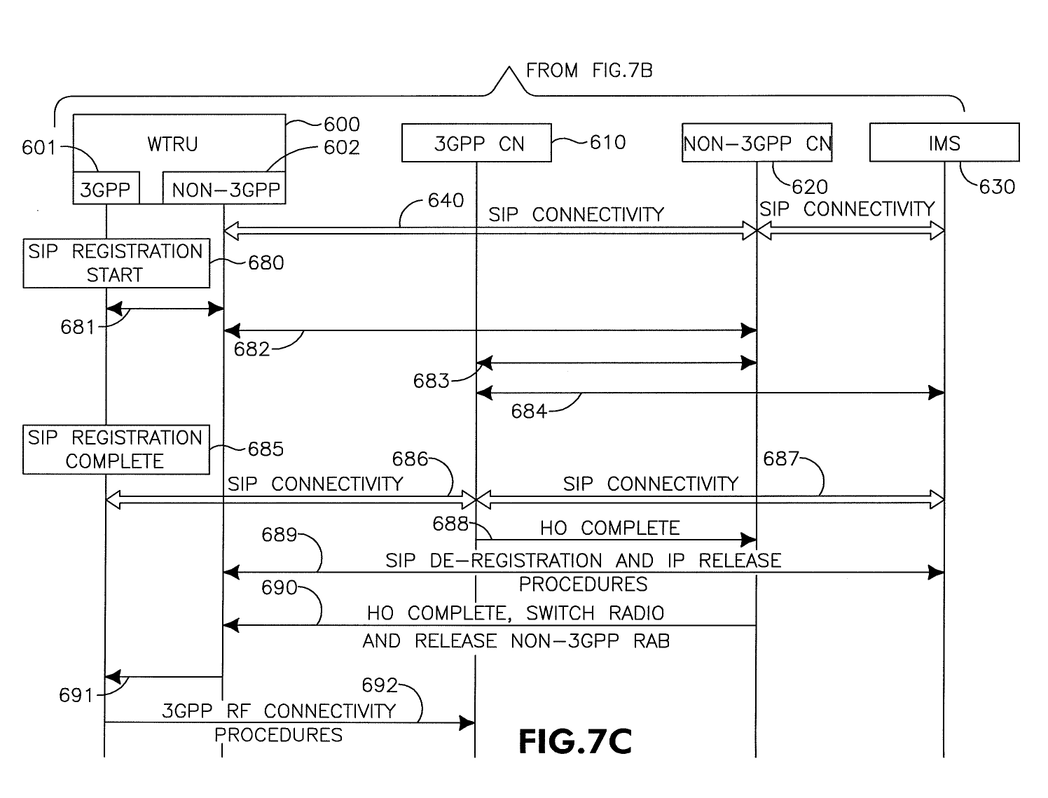

FIGS. 7A, 7B and 7C are a signal diagram for a non-3GPP to 3GPP pre-registration. A WTRU 600 includes a 3GPP radio transceiver 601 and a non-3GPP radio transceiver 602. There is a SIP connection between the non-3GPP radio transceiver 601 in WTRU 600 and a non-3GPP CN 620, and from non-3GPP CN 630 to an IMS 630. Non-3GPP CN 620 may transmit a 3GPP and non-3GPP measurement list (641) to WTRU 600. WTRU 600 can receive the frequency list and store the list in internal memory (642). WTRU 600 may then periodically initiate channel measurements.

Non-3GPP 602 radio in WTRU 600 may then initialize 3GPP radio 601 (643) and send the 3GPP radio 601 a list of 3GPP targets (644). In turn, 3GPP radio 601 may monitor channels and perform measurements (645). The measurement reports can be sent to the non-3GPP radio (646), which then transmits all measurement reports to non-3GPP CN 620 (647).

Non-3GPP CN 620 preferably examines the measurement report and handover criteria, then decides on the target system (648) and initiates a handover direct tunnel to the targeted 3GPP system 610 (649).

After receiving a tunnel establishment acknowledge message (650) from 3GPP network 610, non-3GPP CN 620 may initiate a direct handover tunnel with the 3GPP radio transceiver 601 in WTRU 600 (651) through the non-3GPP radio transceiver 602 (652). The handover tunnel preferably is acknowledged by the 3GPP radio transceiver 601 (653) through non-3GPP radio transceiver 602 (654), and the handover tunnel 655 is established.

Once the tunnel is established, non-3GPP CN 620 may initiate 3GPP registration with 3GPP radio 601 through non-3GPP radio 602(660,661). 3GPP radio transceiver 601 sends a registration request 663 to 3GPP CN 610 through non-3GPP transceiver 602 (662). In request (662, 663), the tunnel endpoint identifier (TEID) is related to non-3GPP CN 620. 3GPP radio transceiver 601 in WTRU 600 along with 3GPP CN 610, conduct authentication procedures (664, 665).

The 3GPP IP configuration is then started (670) and the IP configuration procedures between WTRU 600 and 3GPP CN 620 are conducted (671,672). Once the IP configuration is complete (673), SIP registration is started (680). 3GPP transceiver 602 requests SIP registration through non-3GPP transceiver 602 (681), which communicates this to non-3GPP CN 620 (683), which then communicates with IMS 630 (684). SIP registration information is then sent to 3GPP transceiver 601 along the same signal path (684, 683, 632, 631). Once SIP registration is complete 685, there is SIP connectivity between 3GPP radio transceiver 601 and 3GPP CN 610 (686) and between 3GPP CN 620 and IMS 630 (687).

Handover is completed to 3GPP CN 610 (688), SIP de-registration and IP release procedures are then performed between non-3GPP transceiver 602 and IMS 630 (689), handover to 3GPP CN 610 is completed and the non-3GPP radio bearer is released (690, 691). 3GPP radio transceiver 601 may then complete connection to 3GPP CN 610 (692) with no interruption in SIP and IMS operation.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for handover (HO) in a wireless transmit receive unit (WTRU) from a source system to a target system, the WTRU including a first transceiver and a second transceiver, the method comprising:
a first transceiver radio resource control (RRC) layer included in the first handover communicating the HO message to a second transceiver mobility management (MM) layer included in the second transceiver;
sending a cross communication including an HO acknowledgement from the second transceiver MM layer to the first transceiver RRC layer, whereby the HO acknowledgement is transmitted to the source system by the first transceiver; and
pre-registering the second transceiver by the target system prior to handover, wherein the first transceiver RRC layer cross communicates registration information from the target system to the second transceiver MM layer.

2. The method of claim 1, further comprising receiving at the first transceiver a message to initiate target network registration from the source system, wherein the message is sent to the second transceiver MM layer by the first transceiver RRC layer.

3. The method of claim 1, further comprising:
receiving at the first transceiver a second system measurement list from the first system; and
sending the measurement list to the second transceiver.

4. The method of claim 3, wherein the first transceiver sends to the second transceiver a list of target systems.

5. The method of claim 4, further comprising:
measuring at the second transceiver channels for the list of target systems;
sending a measurement report to the first transceiver; and
transmitting the measurement report to the source system.

6. The method of claim 1, further comprising establishing a direct HO tunnel between the second transceiver and the target systems.

7. The method of claim 4, further comprising initializing the second transceiver for measuring the target system channels.

8. The method of claim 6, further comprising turning off the first transceiver upon handover to the target system.

9. The method of claim 1, wherein the target system is a non-3GPP network and the source system is a 3GPP network.

10. The method of claim 9, wherein the first transceiver is a 3GPP transceiver and the second transceiver is a non-3GPP transceiver.

11. The method of claim 1, wherein the target system is a 3GPP network and the source system is a non-3GPP network.

12. The method of claim 11, wherein the first transceiver is a non-3GPP transceiver and the second transceiver is a 3GPP transceiver.

13. The method of claim 1 wherein the handover is for session initiation protocol (SIP) based handover.

14. The method of claim 13 further comprising:
initiating IP configuration; and
the second transceiver conducting target IP configuration procedures with the target system via the first transceiver.

15. The method of claim 14, further comprising:
providing to the second transceiver the IP configuration for the target system;
the second transceiver conducting target radio contact procedures directly with the target system.

16. The method of claim 13, further comprising:
initiating SIP registration by the second transceiver with the target system through the first transceiver and the source system.

17. The method of claim 16, further comprising:
the first transceiver sending the SIP registration information to the second transceiver.

18. The method of claim 17, further comprising:
establishing SIP connectivity between the second transceiver and the target system.

19. The method of claim 18, further comprising:
de-registering the first transceiver.

20. The method of claim 19, further comprising:
receiving at the first transceiver a handover complete message; and
turning off the first transceiver.

21. The method of claim 20 further comprising:
the second transceiver conducting radio frequency connectivity procedures with the target system.

22. A wireless transmit receive unit (WTRU) configured to conduct handover from a source system to a target system, the WTRU comprising:
a first transceiver for communicating with the source system, including at least a first mobility management (MM) layer and a radio resource control (RRC) layer; and
a second transceiver for communicating with the target system upon handover, including at least a second MM layer and a second RRC layer;
wherein handover is conducted between the source system and the second transceiver through a cross communication link between the first RRC layer and second MM layer and the first MM layer and the second RRC layer;
the cross communication link thereby establishing an handover direct tunnel between the second transceiver and target system.

23. The WTRU of claim 22, wherein the second transceiver receives a HO direct tunnel message, including a target system tunnel endpoint ID, from the source system through the communication link between the first RRC layer and the second MM layer.

24. The WTRU of claim 22, wherein the second transceiver receives target system registration information from the target system through the cross communication between the first RRC layer and the second MM layer, whereby the second transceiver is pre-registered and pre-authenticated by the target system prior to handover.

25. The WTRU of claim 24, wherein the first transceiver is turned off and the second transceiver turned on upon initiating handover to the target system.

26. The WTRU of claim 22, wherein the source system is a 3^{rd} Generation Partnership Project (3GPP) network and the target system is a non-3GPP network.

27. The WTRU of claim 26, wherein the first transceiver is configured to communicate within a 3GPP network and the second transceiver is configured to communicate within a non-3GPP network.

28. The WTRU of claim 22, wherein the source system and the target system is a 3GPP network.

29. The WTRU of claim 28, wherein the first transceiver is configured to communicate with a non-3GPP network and the second transceiver is configured to communicate with a 3GPP network.

30. The WTRU of claim 22, wherein the first transceiver receives a HO direct tunnel message, including a target system tunnel endpoint ID, from the source system through the communication link between the second RRC layer and the first MM layer.

31. The WTRU of claim 22, wherein the first transceiver receives target system registration information from the target system through the cross communication between the second RRC layer and the first MM layer, whereby the first transceiver is pre-registered and pre-authenticated by the target system prior to handover.

32. The WTRU of claim 24, wherein the second transceiver is turned off and the first transceiver turned on upon initiating handover to the target system.
